(19) United States
(12) Patent Application Publication
(10) Pub. No.: US 2024/0428603 A1
(43) Pub. Date: Dec. 26, 2024

(54) RECOGNITION APPARATUS AND RECOGNITION SYSTEM

(71) Applicants: KABUSHIKI KAISHA TOSHIBA, Tokyo (JP); Toshiba Infrastructure Systems & Solutions Corporation, Kawasaki-shi (JP)

(72) Inventors: Masataka Sato, Chigasaki Kanagawa (JP); Kazutaka Asahi, Kawasaki Kanagawa (JP); Takuma Akagi, Tokyo (JP)

(73) Assignees: KABUSHIKI KAISHA TOSHIBA, Tokyo (JP); Toshiba Infrastructure Systems & Solutions Corporation, Kawasaki-shi (JP)

(21) Appl. No.: 18/825,398

(22) Filed: Sep. 5, 2024

Related U.S. Application Data
(63) Continuation of application No. PCT/JP2023/008360, filed on Mar. 6, 2023.

(30) Foreign Application Priority Data
Mar. 8, 2022 (JP) 2022-035571

(51) Int. Cl. G06V 30/148; G06T 3/40; G06T 3/60

(52) U.S. Cl. CPC G06V 30/15; G06T 3/40; G06T 3/60

(57) ABSTRACT

According to an embodiment, a recognition apparatus includes an image interface, an input interface, and a processor. The image interface acquires a character string image including a character string from an input apparatus. The input interface inputs an operation signal to the input apparatus. The processor extracts a region of the character string from the character string image, acquires a size of the region, inputs a transformation operation of transforming the character string image based on the size to the input apparatus through the input interface, acquires the transformed character string image through the image interface, performs character recognition processing on the transformed character string image, and inputs the character string to the input apparatus through the input interface based on a result of the character recognition processing.

### CROSS REFERENCE TO RELATED APPLICATIONS

This application is a Continuation Application of PCT Application No. PCT/JP2023/008360, filed Mar. 6, 2023 and based upon and claiming the benefit of priority from Japanese Patent Application No. 2022-035571, filed Mar. 8, 2022, the entire contents of all of which are incorporated herein by reference.

### FIELD

Embodiments of the present invention relate to a recognition apparatus and a recognition system.

### BACKGROUND

A system for acquiring an input screen including a character string image including a character string such as a destination and an input field for the character string from an existing video coding desk (VCD) is provided. Such a system extracts a region including a character string from an input screen, and performs character recognition processing (optical character recognition (OCR) processing) on the extracted region. Based on the result of the OCR processing, the system inputs, to the existing VCD, a key operation for inputting a character string to an input field.

Conventionally, a system may fail OCR processing depending on a position, an orientation, a size, or the like of a character string included in an input screen.

### BRIEF DESCRIPTION OF THE DRAWINGS

FIG. 1 is a block diagram illustrating an example of a configuration of a recognition system according to an embodiment.

FIG. 2 is a block diagram illustrating an example of a configuration of a first recognition apparatus according to the embodiment.

FIG. 3 is a block diagram illustrating an example of a configuration of an existing VCD according to the embodiment.

FIG. 4 is a block diagram illustrating an example of a configuration of a second recognition apparatus according to the embodiment.

FIG. 5 is a diagram illustrating an example of an input screen according to the embodiment.

FIG. 6 is a flowchart illustrating an example of an operation of the first recognition apparatus according to the embodiment.

FIG. 7 is a flowchart illustrating an example of an operation of the existing VCD according to the embodiment.

FIG. 8 is a flowchart illustrating an example of an operation of the second recognition apparatus according to the embodiment.

### DETAILED DESCRIPTION

According to an embodiment, a recognition apparatus includes an image interface, an input interface, and a processor. The image interface acquires a character string image including a character string from an input apparatus. The input interface inputs an operation signal to the input apparatus. The processor extracts a region of the character string from the character string image, acquires a size of the region, inputs a transformation operation of transforming the character string image based on the size to the input apparatus through the input interface, acquires the transformed character string image through the image interface, performs character recognition processing on the transformed character string image, and inputs the character string to the input apparatus through the input interface based on a result of the character recognition processing.

Hereinafter, embodiments will be described with reference to the drawings.

A recognition system according to an embodiment recognizes a character string from a captured image (character string image) obtained by capturing an image of a character string such as a destination.

In the recognition system, a first recognition apparatus performs character recognition processing (OCR processing) on the captured image. In a case where the OCR processing has succeeded, the recognition system obtains the character string based on a result of the OCR processing. In a case where the OCR processing has failed, the recognition system displays an input screen including the captured image and an input field on an existing VCD, and receives a key input of the character string to the input field.

The recognition system originally receives the key input of the character string from an operator through the existing VCD, but in the embodiment, the recognition system receives the key input from a second recognition apparatus.

In the recognition system, the second recognition apparatus acquires the input screen and performs the OCR processing on the captured image. In a case where the OCR processing has succeeded, the recognition system inputs the key input of the character string to the input field from the second recognition apparatus to the existing VCD based on a result of the OCR processing.

In a case where the OCR processing has failed in the second recognition apparatus, the recognition system displays the acquired input screen on a display unit connected to the second recognition apparatus. The recognition system receives a key input from an operator through an operation unit connected to the second recognition apparatus. The recognition system inputs the key input to the existing VCD.

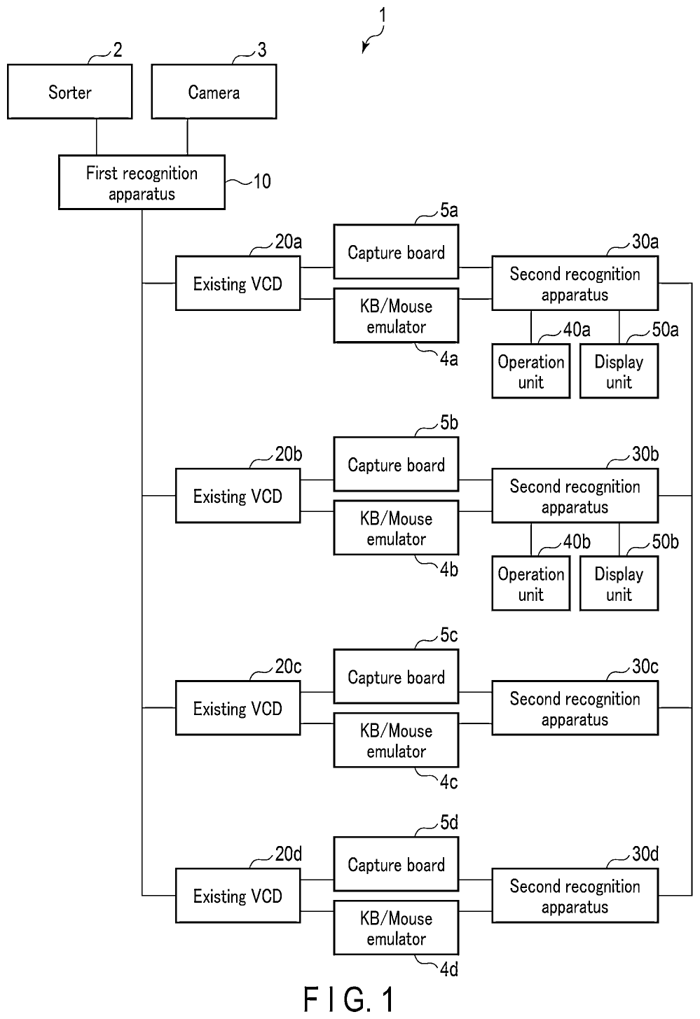

FIG. 1 illustrates an example of a configuration of a recognition system 1 according to an embodiment. As illustrated in FIG. 1, the recognition system 1 includes a sorter 2, a camera 3, a keyboard/mouse emulator 4 (4a to 4d), a capture board 5 (5a to 5d), a first recognition apparatus 10, an existing VCD 20 (20a to 20d), a second recognition apparatus 30 (30a to 30d), an operation unit 40 (40a and 40b), a display unit 50 (50a and 50b), and the like.

The first recognition apparatus 10 is connected to the sorter 2, the camera 3 and the existing VCD 20. The existing VCDs 20a to 20d are connected to the keyboard/mouse emulators 4a to 4d and the capture boards 5a to 5d, respectively. The keyboard/mouse emulators 4a to 4d and the capture boards 5a to 5d are connected to the second recognition apparatuses 30a to 30d, respectively. The second recognition apparatuses 30a and 30b are connected to the operation units 40a and 40b, respectively. In addition, the second recognition apparatuses 30a and 30b are connected to the display units 50a and 50b, respectively.

Note that the recognition system 1 may further include other configurations as necessary in addition to the configuration illustrated in FIG. 1, or a specific configuration may be excluded from the recognition system 1.

The sorter 2 classifies an input article into a sorting destination based on a signal from the first recognition apparatus 10. For example, the sorter 2 includes a plurality of chutes as sorting destinations. The sorter 2 puts the article into the chute based on the signal from the first recognition apparatus 10. For example, the sorter 2 acquires, from the first recognition apparatus 10, sorting information indicating an ID for specifying the article and the sorting destination (e.g., the number of the chute, or the like) for inputting the article. The sorter 2 puts the article into the chute based on the sorting information.

The camera 3 captures an image of the article to be put into the sorter 2. The camera 3 captures an image of a surface (destination surface) on which the destination of the article is described as a character string. For example, the camera 3 is installed above a conveyance path on which the article is put into the sorter 2. The camera 3 may capture images of the article from a plurality of surfaces. The camera 3 transmits the captured image to the first recognition apparatus 10.

The first recognition apparatus 10 performs OCR processing on the image (captured image) from the camera 3, and recognizes the destination as the character string. The first recognition apparatus 10 sets the sorting destination of the article in the sorter 2 based on the recognized destination or the like. For example, the first recognition apparatus 10 transmits, to the sorter 2, the sorting information indicating the ID for identifying the article and the sorting destination into which the article is to be put. The first recognition apparatus 10 will be described in detail later.

The keyboard/mouse emulator 4 emulates an operation terminal such as a keyboard, a mouse, or the like connected to the existing VCD 20. The keyboard/mouse emulator 4 supplies, to the existing VCD 20, an operation signal similar to an operation signal input by the operator through the operation terminal under control by the second recognition apparatus 30. For example, the keyboard/mouse emulator 4 supplies, to the existing VCD 20, an operation signal such as movement of the mouse or clicking or a key input.

Here, the keyboard/mouse emulators 4a to 4d supply operation signals to the existing VCDs 20a to 20d under control by the second recognition apparatuses 30a to 30d, respectively.

The capture board 5 acquires the input screen from the existing VCD 20. The capture board 5 supplies the acquired input screen to the second recognition apparatus 30.

Here, the capture boards 5a to 5d acquire input screens of the existing VCDs 20a to 20d, respectively, and supply the input screens to the second recognition apparatuses 30a to 30d, respectively.

The existing VCD 20 is an input apparatus for acquiring the destination included in the captured image (the captured image of the destination surface) in which the recognition of the destination has failed in a case where the first recognition apparatus 10 has failed in the recognition of the destination. The existing VCD 20 generates an input screen including a captured image and an input field. Originally, the existing VCD 20 displays an input screen on a monitor, and inputs a destination from an operator through an operation unit such as a keyboard. Here, the existing VCD 20 supplies the input screen to the capture board 5. In addition, the existing VCD 20 inputs an operation signal such as a key input of the destination from the keyboard/mouse emulator 4. The existing VCD 20 will be described in detail later.

The second recognition apparatus 30 acquires the input screen from the capture board 5. The second recognition apparatus 30 recognizes the destination from the captured image included in the input screen by OCR processing. The second recognition apparatus 30 inputs the recognized destination to the existing VCD 20 through the keyboard/mouse emulator 4. The second recognition apparatus 30 will be described in detail later.

The operation unit 40 receives various operations input from the operator. The operation unit 40 transmits a signal indicating the input operations to the second recognition apparatus 30. The operation unit 40 includes a keyboard, a button, a touch panel, or the like.

The display unit 50 displays information based on control by the second recognition apparatus 30. For example, the display unit 50 includes a liquid crystal monitor. In a case where the operation unit 40 includes a touch panel, the display unit 50 includes a liquid crystal monitor formed integrally with the operation unit 40.

Note that the recognition system 1 may include an operation unit and a display unit connected to the second recognition apparatuses 30c and 30d, respectively.

Next, the first recognition apparatus 10 will be described.

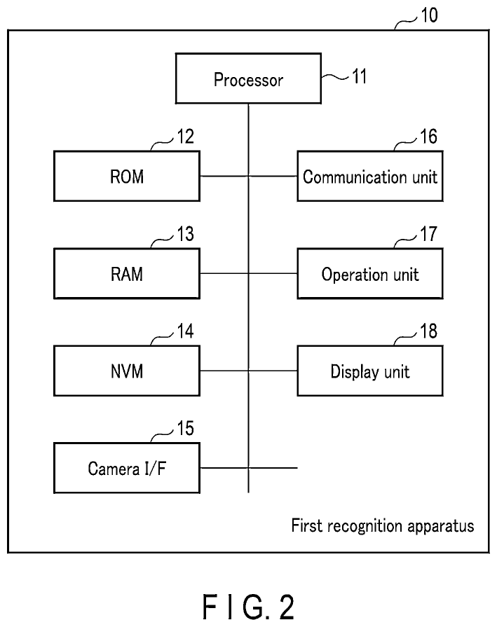

FIG. 2 illustrates an example of a configuration of the first recognition apparatus 10. As illustrated in FIG. 2, the first recognition apparatus 10 includes a processor 11, a ROM 12, a RAM 13, an NVM 14, a camera interface 15, a communication unit 16, an operation unit 17, a display unit 18, and the like. The processor 11 is communicably connected to the ROM 12, the RAM 13, the NVM 14, the camera interface 15, the communication unit 16, the operation unit 17, and the display unit 18 via a data bus, a predetermined interface, or the like.

Note that the first recognition apparatus 10 may further include other configurations as necessary in addition to the configuration illustrated in FIG. 2, or a specific configuration may be excluded from the first recognition apparatus 10.

The processor 11 has a function of controlling the entire operation of the first recognition apparatus 10. The processor 11 may include an internal cache, various interfaces, and the like. The processor 11 implements various types of processing by executing a program stored in advance in the internal memory, the ROM 12, or the NVM 14.

Note that some of the various functions implemented by the processor 11 executing the program may be implemented by a hardware circuit. In this case, the processor 11 controls the functions executed by the hardware circuit.

The ROM 12 is a nonvolatile memory in which a control program, control data, and the like are stored in advance. The control program and the control data stored in the ROM 12 are incorporated in advance according to the specifications of the first recognition apparatus 10.

The RAM 13 is a volatile memory. The RAM 13 temporarily stores data and the like being processed by the processor 11. The RAM 13 stores various application programs based on instructions from the processor 11. The RAM 13 may store data necessary for execution of the application programs, execution results of the application programs, and the like.

The NVM 14 is a nonvolatile memory to which data can be written and rewritten. For example, the NVM 14 includes, for example, an HDD, an SSD, a flash memory, or the like. The NVM 14 stores the control program, an application, various data, and the like according to the operation application of the first recognition apparatus 10.

The camera interface 15 is an interface for transmitting and receiving data to and from the camera 3. For example, the camera interface 15 is connected to the camera 3 by wire. The camera interface 15 receives the captured image from the camera 3. The camera interface 15 transmits the received captured image to the processor 11. Furthermore, the camera interface 15 may supply power to the camera 3.

The communication unit 16 is an interface for transmitting and receiving data to and from the sorter 2, the existing VCD 20, and the like. For example, the communication unit 16 supports local area network (LAN) connection. Furthermore, for example, the communication unit 16 may support universal serial bus (USB) connection. Note that the communication unit 16 may include an interface for transmitting and receiving data to and from the first recognition apparatus 10, and an interface for transmitting and receiving data to and from the existing VCD 20.

The operation unit 17 receives various operations input from the operator. The operation unit 17 transmits a signal indicating the input operations to the processor 11. The operation unit 17 includes a keyboard, a button, a touch panel, or the like.

The display unit 18 displays information based on control by the processor 11. For example, the display unit 18 includes a liquid crystal monitor. In a case where the operation unit 17 includes a touch panel, the display unit 18 includes a liquid crystal monitor formed integrally with the operation unit 17.

Next, the existing VCD 20 will be described. Since the existing VCDs 20a to 20d have the same configuration, they will be described as an existing VCD 20.

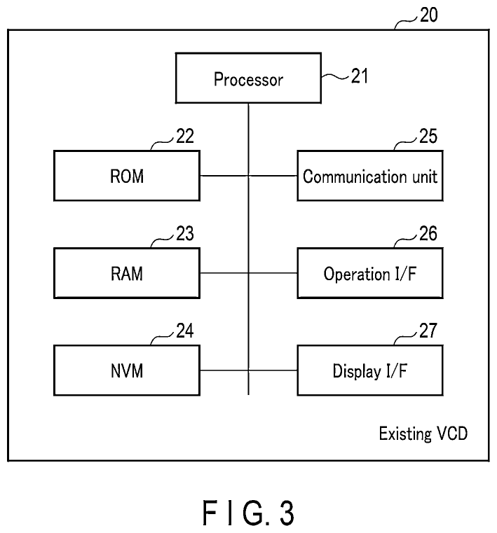

FIG. 3 illustrates an example of a configuration of the existing VCD 20. As illustrated in FIG. 3, the existing VCD 20 includes a processor 21, a ROM 22, a RAM 23, an NVM 24, a communication unit 25, an operation interface 26, a display interface 27, and the like.

The processor 21, the ROM 22, the RAM 23, the NVM 24, the communication unit 25, the operation interface 26, and the display interface 27 are connected to each other via a data bus or the like.

Note that the existing VCD 20 may have other configurations as necessary in addition to the configuration illustrated in FIG. 3, or a specific configuration may be excluded from the existing VCD 20.

The processor 21 has a function of controlling the entire operation of the existing VCD 20. The processor 21 may include an internal cache, various interfaces, and the like. The processor 21 implements various types of processing by executing a program stored in advance in the internal memory, the ROM 22, or the NVM 24.

Note that some of the various functions implemented by the processor 21 executing the program may be implemented by a hardware circuit. In this case, the processor 21 controls the functions executed by the hardware circuit.

The ROM 22 is a nonvolatile memory in which a control program, control data, and the like are stored in advance. The control program and the control data stored in the ROM 22 are incorporated in advance according to the specifications of the existing VCD 20.

The RAM 23 is a volatile memory. The RAM 23 temporarily stores data and the like being processed by the processor 21. The RAM 23 stores various application programs based on instructions from the processor 21. The RAM 23 may store data necessary for execution of the application programs, execution results of the application programs, and the like.

The NVM 24 is a nonvolatile memory to which data can be written and rewritten. For example, the NVM 24 includes, for example, an HDD, an SSD, a flash memory, or the like. The NVM 24 stores the control program, an application, various data, and the like according to the operation application of the existing VCD 20.

The communication unit 25 (communication interface) is an interface for transmitting and receiving data to and from the first recognition apparatus 10 and the like. For example, the communication unit 25 is an interface that supports wired or wireless LAN connection.

The operation interface 26 is an interface for receiving an operation input from the operation terminal. For example, the operation interface 26 receives an operation signal indicating an operation input to an operation terminal such as a keyboard or a mouse. The operation interface 26 supplies the received operation signal to the processor 21. For example, the operation interface 26 supports USB connection.

Here, the operation interface 26 is connected to the keyboard/mouse emulator 4. That is, the operation interface 26 receives an operation signal from the keyboard/mouse emulator 4.

The display interface 27 is an interface that outputs a screen to a display unit such as a monitor. Here, the display interface 27 is connected to the capture board 5. The display interface 27 is an interface that transmits and receives data to and from the capture board 5. The display interface 27 transmits the input screen to the capture board 5 under control by the processor 21.

For example, the existing VCD 20 is a desktop PC, a laptop PC, or the like.

Next, the second recognition apparatus 30 will be described. Since the second recognition apparatuses 30a to 30d have the same configuration, they will be described as a second recognition apparatus 30.

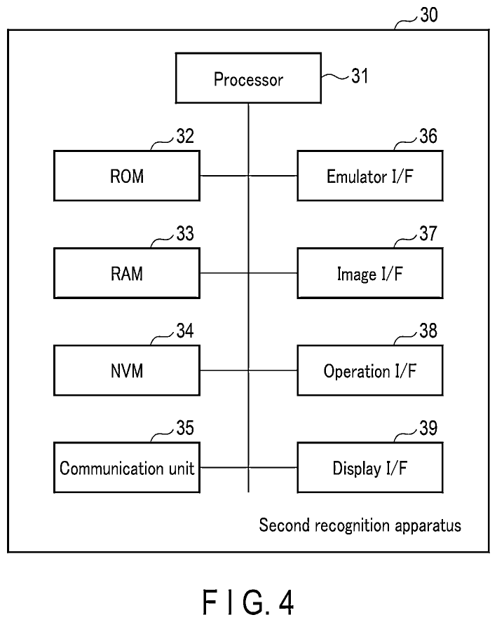

FIG. 4 illustrates an example of a configuration of the second recognition apparatus 30 according to the embodiment. FIG. 4 is a block diagram illustrating the example of the configuration of the second recognition apparatus 30. As illustrated in FIG. 4, the second recognition apparatus 30 includes a processor 31, a ROM 32, a RAM 33, an NVM 34, a communication unit 35, an emulator interface 36, an image interface 37, an operation interface 38, a display interface 39, and the like.

The processor 31, the ROM 32, the RAM 33, the NVM 34, the communication unit 35, the emulator interface 36, the image interface 37, the operation interface 38, and the display interface 39 are connected to each other via a data bus or the like.

Note that the second recognition apparatus 30 may have other configurations as necessary in addition to the configuration illustrated in FIG. 4, or a specific configuration may be excluded from the second recognition apparatus 30.

The processor 31 has a function of controlling the entire operation of the second recognition apparatus 30. The processor 31 may include an internal cache, various interfaces, and the like. The processor 31 implements various types of processing by executing a program stored in advance in the internal memory, the ROM 32, or the NVM 34.

Note that some of the various functions implemented by the processor 31 executing the program may be implemented by a hardware circuit. In this case, the processor 31 controls the functions executed by the hardware circuit.

The ROM 32 is a nonvolatile memory in which a control program, control data, and the like are stored in advance. The control program and the control data stored in the ROM 32 are incorporated in advance according to the specifications of the second recognition apparatus 30.

The RAM 33 is a volatile memory. The RAM 33 temporarily stores data and the like being processed by the processor 31. The RAM 33 stores various application programs based on instructions from the processor 31. The RAM 33 may store data necessary for execution of the application programs, execution results of the application programs, and the like.

The NVM 34 is a nonvolatile memory to which data can be written and rewritten. For example, the NVM 34 includes, for example, an HDD, an SSD, a flash memory, or the like. The NVM 34 stores the control program, an application, various data, and the like according to the operation application of the second recognition apparatus 30.

The communication unit 35 is an interface for transmitting and receiving data to and from another second recognition apparatus 30 and the like. For example, the communication unit 35 is an interface that supports wired or wireless LAN connection.

The emulator interface 36 (input interface) is an interface that transmits and receives data to and from the keyboard/mouse emulator 4. The emulator interface 36 causes the keyboard/mouse emulator 4 to output an operation signal to the existing VCD 20 under control by the processor 31. That is, the emulator interface 36 inputs an operation signal to the existing VCD 20 through the keyboard/mouse emulator 4. For example, the emulator interface 36 supports USB connection.

The image interface 37 is an interface that transmits and receives data to and from the capture board 5. The image interface 37 acquires the input screen of the existing VCD 20 from the capture board 5. The image interface 37 supplies the acquired input screen to the processor 31.

The operation interface 38 is an interface for transmitting and receiving data to and from the operation unit 40. For example, the operation interface 38 receives, from the operation unit 40, an operation signal indicating an operation input to the operation unit 40. The operation interface 38 transmits the received operation signal to the processor 31. Furthermore, the operation interface 38 may supply power to the operation unit 40. For example, the operation interface 38 supports USB connection.

The display interface 39 is an interface for transmitting and receiving data to and from the display unit 50. The display interface 39 outputs image data from the processor 31 to the display unit 50.

For example, the second recognition apparatus 30 is a desktop PC, a laptop PC, or the like.

Note that the emulator interface 36, the image interface 37, the operation interface 38, and the display interface 39 (or some of them) may be integrally formed.

In addition, the second recognition apparatuses 30c and 30d may not include the operation interface 38 and the display interface 39.

Next, functions implemented by the first recognition apparatus 10 will be described. The functions implemented by the first recognition apparatus 10 are implemented by the processor 11 executing a program stored in the ROM 12, the NVM 14, or the like.

First, the processor 11 has a function of acquiring a captured image including a destination surface from the camera 3.

Here, the camera 3 captures an image at the timing when the article passes through a capturing region of the camera 3. The camera 3 transmits the captured image to the first recognition apparatus 10.

The processor 11 acquires the captured image including the destination surface from the camera 3 through the camera interface 15. Note that the processor 11 may transmit a request to the camera 3 and receive a response including the captured image.

In addition, the processor 11 has a function of acquiring a destination from a captured image by the OCR processing.

When the processor 11 acquires the captured image, the processor 11 performs the OCR processing on the captured image according to a predetermined algorithm (first algorithm). When performing the OCR processing, processor 11 acquires the destination described on the destination surface of the article based on a result of the OCR processing.

In addition, the processor 11 has a function of acquiring a destination through the existing VCD 20 in a case where the OCR processing has failed.

In a case where the OCR processing fails and the destination cannot be acquired, the processor 11 transmits the captured image to the existing VCD 20 through the communication unit 16. The processor 11 selects one existing VCD 20 from among the existing VCDs 20a to 20d, and transmits the captured image to the selected existing VCD 20.

As will be described later, the existing VCD 20 inputs the destination described on the destination surface included in the captured image to the first recognition apparatus 10.

The processor 11 acquires the destination from the existing VCD 20 through the communication unit 16.

The processor 11 has a function of setting a sorting destination of an article based on a destination acquired by the OCR processing or a destination input from the existing VCD 20.

For example, the processor 11 sets, in the sorter 2, the number of the chute into which the article is put as the sorting destination based on the destination. For example, the processor 11 sets a number of a chute corresponding to a destination administrative district (a prefecture, a municipality, or the like).

The processor 11 transmits the sorting information indicating the ID for specifying the article and the sorting destination of the article to the sorter 2 through the communication unit 16.

Next, functions implemented by the existing VCD 20 will be described. The functions implemented by the existing VCD 20 are implemented by the processor 21 executing a program stored in the ROM 22, the NVM 24, or the like.

First, the processor 21 has a function of acquiring a captured image including a destination surface from the first recognition apparatus 10.

As described above, when the OCR processing fails, the processor 11 of the first recognition apparatus 10 transmits the captured image to the existing VCD 20.

The processor 21 of the existing VCD 20 acquires the captured image from the first recognition apparatus 10 through the communication unit 25.

In addition, the processor 21 has a function of transmitting an input screen including an acquired captured image to the capture board 5.

When the processor 21 acquires the captured image, the processor 21 generates an input screen that receives input of a destination appearing in the captured image. The input screen includes the acquired captured image.

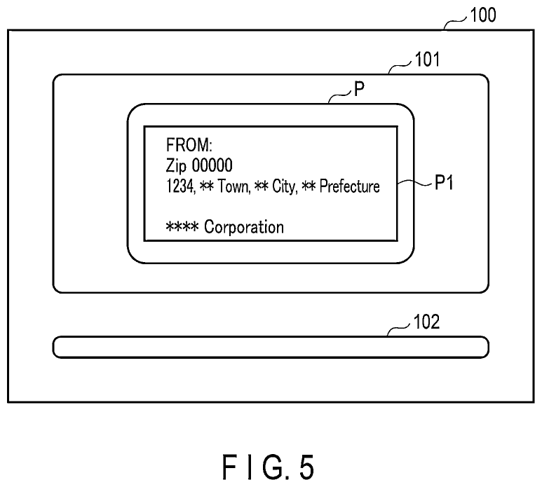

FIG. 5 illustrates an example of an input screen 100 generated by the processor 21. As illustrated in FIG. 5, the input screen 100 includes an image region 101, an input field 102, and the like.

The image region 101 displays at least a part of a captured image acquired from the first recognition apparatus 10. The processor 21 enlarges, reduces, rotates, or trims the captured image and displays the image in the image region 101. The image resolution of the captured image displayed in the image region 101 may be lower than the image resolution of the image captured by the camera 3.

In the example illustrated in FIG. 5, the image region 101 includes an article P. A form P1 in which a destination is described is attached to the article P. Here, the image region 101 displays a surface (destination surface) to which the form P1 is attached.

The input field 102 is formed below the image region 101. The input field 102 receives an input of a destination appearing in the captured image displayed in the image region 101.

Furthermore, the input screen 100 may include an icon or the like for confirming the input to the input field 102.

Furthermore, the input field 102 may be formed in an upper portion of the image region 101.

The configuration of the input screen is not limited to the specific configuration.

When the processor 21 generates the input screen, the processor 21 outputs the generated input screen through the display interface 27. The processor 21 outputs the input screen similarly to a case where a display apparatus such as a monitor is connected to the display interface 27. That is, the processor 21 outputs, to the capture board 5 through the display interface 27, a signal similar to a signal output to the display apparatus such as the monitor.

In addition, the processor 21 has a function of inputting an operation (transformation operation) of transforming the display of the image region 101 through the operation interface 26.

For example, the transformation operation is an operation of enlarging, reducing, rotating, or moving the captured image displayed in the image region 101.

For example, the processor 21 inputs an operation signal for enlarging the captured image at a predetermined magnification as the transformation operation.

In addition, the processor 21 inputs an operation signal for reducing the captured image at a predetermined magnification as the transformation operation.

In addition, the processor 21 inputs an operation signal for rotating the captured image by a predetermined angle as the transformation operation. For example, the processor 21 inputs an operation of rotating the captured image clockwise or counterclockwise by 90 degrees or an operation signal for rotating the captured image by 180 degrees.

In addition, the processor 21 inputs an operation signal for moving the captured image by a predetermined distance (a predetermined number of pixels) in the horizontal direction or the vertical direction as the transformation operation.

When the processor 21 inputs the transformation operation, the processor 21 updates the input screen according to the input transformation operation. That is, the processor 21 updates the image in the image region 101.

For example, when the processor 21 inputs an operation signal of a transformation operation of enlarging the captured image, the processor 21 enlarges the captured image more than the captured image in the current image region 101 and trims the captured image so as to fall within the image region 101. The processor 21 displays the enlarged and trimmed captured image in the image region 101. Furthermore, the resolution of the captured image in the image region 101 increases due to the enlargement.

For example, the processor 21 inputs a key input (e.g., a function key+ “1”) as the transformation operation through the operation interface 26.

In addition, the input screen may display an icon regarding the transformation operation. The processor 21 may detect a tap on the icon as the transformation operation.

Note that the content of the transformation operation is not limited to a specific configuration.

In addition, the processor 21 may input a plurality of transformation operations and update the image in the image region 101.

In addition, the processor 21 has a function of inputting a destination through the operation interface 26.

When the processor 21 outputs the input screen, the processor 21 inputs a destination through the operation interface 26. The processor 21 acquires an operation signal (an operation signal indicating a key input or the like) similar to a case where an operation unit is connected to the operation interface 26. Here, the processor 21 acquires a signal generated by the keyboard/mouse emulator 4 through the operation interface 26.

In addition, the processor 21 has a function of transmitting an input destination to the first recognition apparatus 10.

When the processor 21 receives an operation signal (e.g., an operation signal in which an Enter key is pressed, or the like) whose input is confirmed through the operation interface 26, the processor 21 transmits, to the first recognition apparatus 10, the destination input through the communication unit 25.

Next, functions implemented by the second recognition apparatus 30 will be described. The functions implemented by the second recognition apparatus 30 are implemented by the processor 31 executing a program stored in the ROM 32, the NVM 34, or the like.

First, the processor 31 has a function of acquiring an input screen from the existing VCD 20 through the image interface 37.

Here, the capture board 5 acquires the input screen from the existing VCD 20 and supplies the input screen to the second recognition apparatus 30. The processor 31 acquires the input screen from the capture board 5 through the image interface 37. That is, the processor 31 acquires the captured image including the destination surface from the existing VCD 20.

In addition, the processor 31 has a function of acquiring the position, orientation, and size of the region (destination region) of a destination in a captured image included in the input screen.

Here, the processor 31 acquires the position, orientation, and size of the form P1 as the destination region.

When the processor 31 acquires the input screen, the processor 31 extracts the captured image from the input screen according to a format or the like stored in advance by the NVM 34. That is, the processor 31 extracts the image in the image region 101 of the input screen as the captured image.

When the processor 31 extracts the captured image, the processor 31 acquires the position, orientation, and size of the destination region in the captured image according to a predetermined algorithm.

For example, the NVM 34 stores in advance a model (e.g., a neural network) that outputs the position, orientation, and size of the destination region when the captured image is input.

The processor 31 inputs the extracted captured image into the model to acquire the position, orientation, and size of the destination region.

Note that the NVM 34 may store in advance a model that outputs the position of the destination region when the captured image is input, a model that outputs the direction of the destination region when the captured image is input, and a model that outputs the size of the destination region when the captured image is input. In this case, the processor 31 inputs the extracted captured image to each model to acquire the position, orientation, and size of the destination region.

In addition, the processor 31 has a function of determining whether to input a transformation operation to the existing VCD 20 based on the position, orientation, and size of a destination region.

That is, the processor 31 determines whether the OCR processing can be appropriately performed on the captured image in the image region 101.

For example, the processor 31 determines whether the size of the destination region is a predetermined size or more. In a case where the size of the destination region is smaller than the predetermined size, the processor 31 determines to input a transformation operation of making the size of the destination region equal to or larger than the predetermined size. For example, the processor 31 determines to input a transformation operation of enlarging the captured image in the image region 101.

In addition, the processor 31 determines whether the orientation of the destination region is correct. That is, the processor 31 determines whether or not the destination is correct. When the processor 31 determines that the orientation of the destination region is not correct, the processor 31 determines to input a transformation operation of causing the orientation of the destination region to be correct. For example, in a case where the orientation of the destination region is inclined to the left by 90 degrees, the processor 31 determines to input a transformation operation of rotating the captured image in the image region 101 to the right by 90 degrees.

In addition, the processor 31 determines whether the destination region is out of view. When the processor 31 determines that the destination region is out of view, the processor 31 determines to input a transformation operation of causing the destination region to fall within the image region 101. For example, in a case where the right end of the destination region is out of view, the processor 31 determines to input a transformation operation of moving the captured image in the image region 101 to the left. In a case where the destination region does not fall within the image region 101, the processor 31 determines to input a transformation operation of reducing the captured image in the image region 101.

Furthermore, the processor 31 may determine to input a plurality of transformation operations. For example, the processor r 31 may determine to input a transformation operation of enlarging the captured image in the image region 101 and a transformation operation of moving the captured image such that the enlarged destination region falls within the image region 101.

A transformation operation determined to be input by the processor 31 is not limited to a specific configuration.

In addition, the processor 31 has a function of inputting, to the existing VCD 20, an operation signal for instructing a transformation operation determined to be input.

When the processor 31 determines to input the transformation operation, the processor 31 transmits, to the operation interface 26 of the existing VCD 20, an operation signal for instructing the transformation operation determined to be input by using the keyboard/mouse emulator 4. That is, the processor 31 causes the keyboard/mouse emulator 4 to generate an operation signal (e.g., key input) for instructing a transformation operation through the emulator interface 36, and causes the keyboard/mouse emulator 4 to output the operation signal to the operation interface 26 of the existing VCD 20.

When the processor 31 inputs the operation signal of the transformation operation to the existing VCD 20, the processor 31 acquires the captured image in the updated (transformed) image region 101 and extracts the destination region.

In addition, the processor 31 has a function of acquiring a destination from a destination region by the OCR processing.

When the processor 31 extracts the destination region (the original destination region or the destination region extracted after the update), the processor 31 performs OCR processing on the destination region according to a predetermined algorithm (second algorithm) different from the first algorithm. The second algorithm can recognize at least some of characters that the first algorithm cannot recognize.

When performing the OCR processing, processor 31 acquires the destination described on the destination surface of the article based on a result of the OCR processing.

Note that the processor 31 may perform predetermined processing on the image in the destination region before performing the OCR processing. For example, the processor 31 may enlarge or reduce the image in the destination region. Furthermore, the processor 31 may perform processing of removing noise or the like on the image in the destination region.

In addition, the processor 31 has a function of inputting a destination acquired by the OCR processing to the existing VCD 20.

When the processor 31 acquires the destination by the OCR processing, the processor 31 transmits the acquired destination to the operation interface 26 of the existing VCD 20 by using the keyboard/mouse emulator 4. That is, the processor 31 causes the keyboard/mouse emulator 4 to generate an operation signal (e.g., key input) for inputting the destination to the input field 102 through the emulator interface 36 and causes the keyboard/mouse emulator 4 to output the operation signal to the operation interface 26 of the existing VCD 20.

In addition, the processor 31 may input an operation signal indicating an operation of completing the input of the destination to the existing VCD 20.

In addition, the processor 31 has a function of inputting, to the operation interface 26, an operation signal indicating an operation input to the operation unit 40 in a case where the OCR processing has failed.

In a case where the OCR processing has failed, the processor 31 displays the input screen from the existing VCD 20 on the display unit 50. When the input screen is displayed on the display unit 50, the processor 31 receives an input to the operation unit 40. When the processor 31 receives the input to the operation unit 40, the processor 31 inputs an operation signal indicating the input operation to the existing VCD 20 through the emulator interface 36.

In addition, the processor 31 may update the input screen on the display unit 50. That is, the processor 31 acquires the input screen from the display interface 27 in real time and displays the input screen on the display unit 50.

Here, the operator visually checks the image region of the input screen displayed on the display unit 50 and inputs the destination to the operation unit 40. When the input of the destination is completed, the operator inputs an operation of completing the input to the operation unit 40.

In a case where the operation unit 40 and the display unit 50 are not connected to the second recognition apparatus 30, the processor 31 displays the input screen on the display unit 50 connected to another second recognition apparatus 30. In addition, the processor 31 inputs, to the existing VCD 20, an operation signal indicating the operation input to the operation unit 40 connected to the other second recognition apparatus 30.

For example, the main second recognition apparatus 30 (e.g., the second recognition apparatus 30a) or an external control apparatus may manage the operation unit 40 used to input the destination and the display unit 50 that displays the input screen.

Next, an example of an operation of the first recognition apparatus 10 will be described.

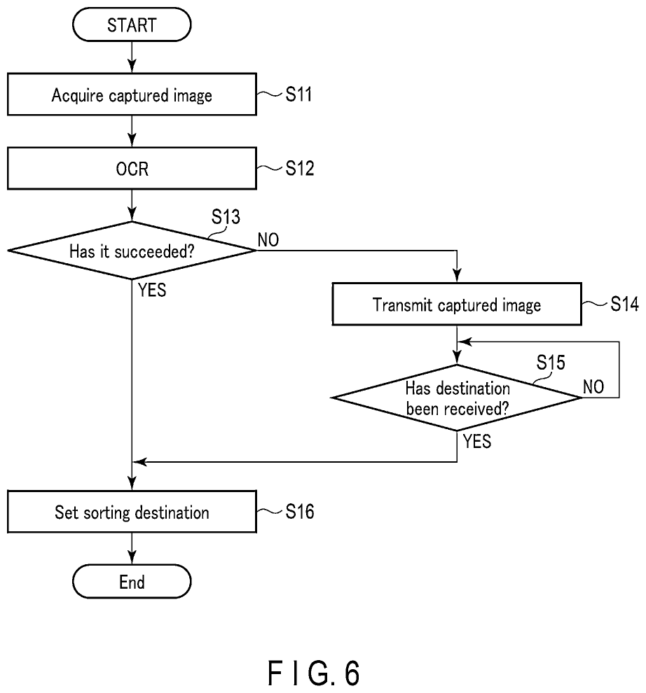

FIG. 6 is a flowchart for explaining the example of the operation of the first recognition apparatus 10.

First, the processor 11 of the first recognition apparatus 10 acquires the captured image including the destination surface of the article through the camera interface 15 (S11). When the processor 11 acquires the captured image, the processor 11 performs the OCR processing on the captured image according to the first algorithm (S12).

When the acquisition of the destination by the OCR processing fails (S13, NO), the processor 11 transmits the captured image to the existing VCD 20 through the communication unit 16 (S14). When the processor 11 transmits the captured image to the existing VCD 20, the processor 11 determines whether the destination has been received from the existing VCD 20 through the communication unit 16 (S15).

When the processor 11 determines that the destination has not been received from the existing VCD 20 (S15, NO), the processor 11 returns to S15.

In a case where the acquisition of the destination by the OCR processing has succeeded (S13, YES) or in a case where it has been determined that the destination has been received from the existing VCD 20 (S15, YES), the processor 11 sets the sorting destination of the article in the sorter 2 based on the destination acquired by the OCR processing or the destination received from the existing VCD 20 (S16).

When the sorting destination of the article is set in the sorter 2, the processor 11 terminates the operation.

Next, an example of an operation of the existing VCD 20 will be described.

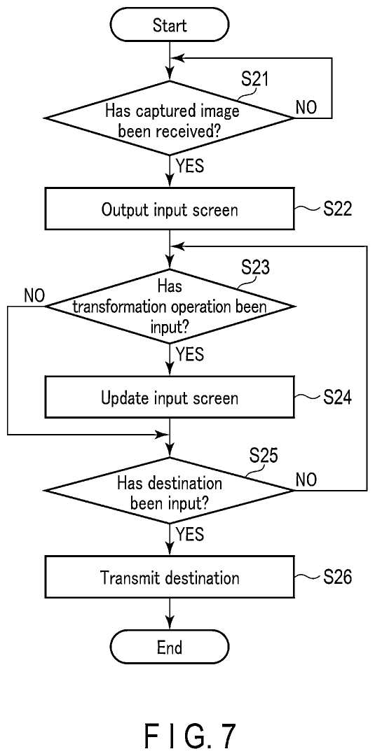

FIG. 7 is a flowchart for explaining the example of the operation of the existing VCD 20.

First, the processor 11 of the existing VCD 20 determines whether the captured image has been received from the first recognition apparatus 10 through the communication unit 25 (S21). When the processor 11 determines that the captured image has not been received from the first recognition apparatus 10 (S21, NO), the processor 11 returns to S21.

When the processor 21 determines that the captured image is received from the first recognition apparatus 10 (S21, YES), the processor 21 outputs the input screen including the captured image through the display interface 27 (S22).

When the processor 21 outputs the input screen, the processor 21 determines whether the transformation operation has been input through the operation interface 26 (S23). When the processor 21 determines that the transformation operation has been input (S23, YES), the processor 21 updates the input screen according to the input transformation operation (S24).

In a case where it has been determined that the transformation operation has not been input (S23, NO) or in a case where the input screen has been updated in accordance with the input transformation operation (S24), the processor 21 determines whether the destination has been input through the operation interface 26 (S25). When the processor 21 determines that the destination has not been received from the existing VCD 20 (S25, NO), the processor 21 returns to S23.

When the processor 21 determines that the destination has been input (S25, YES), the processor 21 transmits the input destination to the first recognition apparatus 10 through the communication unit 25 (S26). When the processor 21 transmits the input destination to the first recognition apparatus 10, the processor 21 ends the operation.

Next, an example of an operation of the second recognition apparatus 30 will be described.

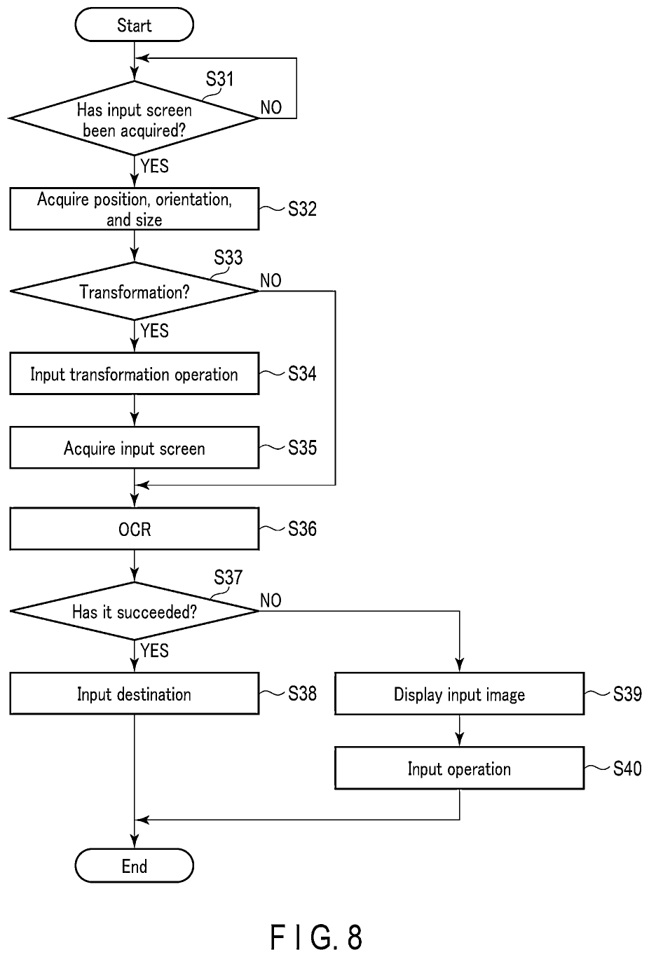

FIG. 8 is a flowchart for explaining the example of the operation of the second recognition apparatus 30.

The processor 31 of the second recognition apparatus 30 determines whether the input screen has been acquired through the image interface 37 (S31). When the processor 31 determines that the input screen has not been acquired (S31, NO), the processor 31 returns to S31.

When the processor 31 determines that the input screen has been acquired (S31, YES), the processor 31 acquires the position, orientation, and size of the destination region (S32). When the processor 31 acquires the position, orientation, and size of the destination region, the processor 31 determines whether to input a transformation operation to the existing VCD 20 based on the position, orientation, and size of the destination region (S33).

When the processor 31 determines to input the transformation operation to the existing VCD 20 (S33, YES), the processor 31 inputs an operation signal of the transformation operation to the existing VCD 20 through the emulator interface 36 (S34).

When the processor 31 inputs the transformation operation to the existing VCD 20, the processor 31 acquires the updated input screen through the image interface 37 (S35).

In a case where it has been determined that the transformation operation has not been input to the existing VCD 20 (S33, NO) or in a case where the updated input screen has been acquired (S35), the processor 31 performs the OCR processing on the image in the destination region according to the second algorithm (S36).

When the acquisition of the destination by the OCR processing succeeds (S37, YES), the processor 31 inputs an operation signal indicating a key input operation for inputting the destination to the existing VCD 20 through the emulator interface 36 (S38).

When the acquisition of the destination by the OCR processing fails (S37, NO), the processor 31 displays the input screen on the display unit 50 (S39). When the processor 31 displays the input screen, the processor 31 inputs an operation signal indicating the operation input to the operation unit 40 to the existing VCD 20 (S40). Here, the processor 31 executes S40 until the processor 31 receives the input of the completely input operation.

In a case where the operation signal indicating the key input operation for inputting the destination has been input to the existing VCD 20 (S38) or in a case where the operation signal indicating the operation input to the operation unit 40 has been input to the existing VCD 20 (S40), the processor 31 ends the operation.

Note that the processor 31 of the second recognition apparatus 30 may not input, to the existing VCD 20, the transformation operation of rotating the captured image in the image region 101 by a predetermined angle. In this case, the processor 31 may perform the OCR processing after rotating the image in the destination region to an appropriate direction. In addition, the processor 31 may display, on the display unit 50, the input screen obtained by rotating the image in the destination region to the appropriate direction.

In a case where the acquisition of the destination by the OCR processing has failed (S37, NO), the processor 31 may return to S32. In this case, the processor 31 may proceed to S39 in a case where the number of times that the acquisition of the destination by the OCR processing has failed exceeds a predetermined threshold.

Before S32, the processor 31 may perform the OCR processing on the destination region. In this case, in a case where the acquisition of the destination by the OCR processing has failed, the processor 31 may execute S32 to S35.

Note that the second recognition apparatus 30 may be connected to a plurality of operation units and a plurality of display units.

Furthermore, the second recognition apparatus 30 may be formed integrally with the operation unit and the display unit.

The OCR processing by the second algorithm may be executed by an external apparatus. For example, the OCR processing by the second algorithm is executed by cloud computing. In this case, the processor 31 of the second recognition apparatus 30 transmits the captured image to the external apparatus. The processor 31 acquires a result of the OCR processing from the external apparatus or the like.

Furthermore, the first recognition apparatus 10 may be formed integrally with the existing VCD 20.

Furthermore, the first recognition apparatus 10 may be formed integrally with the camera 3.

Furthermore, the first recognition apparatus 10 may be formed integrally with the sorter 2.

In addition, the existing VCD 20 may include an operation unit and a display unit.

Furthermore, the recognition system 1 may recognize a character string other than the destination of the article. The character string recognized by the recognition system 1 is not t limited to a specific configuration.

In the recognition system configured as described above, the second recognition apparatus acquires the position, orientation, and size of the destination region from the input screen displayed by the existing VCD. The recognition system inputs a transformation operation of transforming the captured image of the input screen from the second recognition apparatus to the existing VCD based on the position, orientation, and size of the destination region. As a result, in the recognition system, the second recognition apparatus can acquire, from the input screen, the captured image in a state suitable for OCR processing. Therefore, the recognition system can effectively perform OCR processing.

Although some embodiments of the present invention have been described, these embodiments have been presented as examples, and are not intended to limit the scope of the invention. These novel embodiments can be implemented in various other forms, and various omissions, substitutions, and changes can be made without departing from the gist of the invention. These embodiments and modifications thereof are included in the scope and gist of the invention, and are included in the invention described in the claims and the equivalent scope thereof.

1. A recognition apparatus comprising:
an image interface that acquires a character string image including a character string from an input apparatus;
an input interface that inputs an operation signal to the input apparatus; and
a processor that extracts a region of the character string from the character string image, acquires a size of the region, inputs a transformation operation of transforming the character string image based on the size to the input apparatus through the input interface, acquires the transformed character string image through the image interface, performs character recognition processing on the transformed character string image, and inputs the character string to the input apparatus through the input interface based on a result of the character recognition processing.

2. The recognition apparatus according to claim 1, wherein in a case where the size is smaller than a predetermined size, the processor inputs, to the input apparatus through the input interface, a transformation operation of enlarging the character string image such that the size of the region is the predetermined size.

3. The recognition apparatus according to claim 1, wherein the processor acquires an orientation of the region, inputs, to the input apparatus, a transformation operation of rotating the character string image such that the orientation of the region is correct.

4. The recognition apparatus according to claim 1, wherein the processor acquires a position of the region, and inputs, to the input apparatus, a transformation operation of moving the character string image such that the region is in the character string image in a case where the region is out of view.

5. The recognition apparatus according to claim 1, wherein the character string image is an image for which character recognition processing has failed in another apparatus.

6. The recognition apparatus according to claim 1, wherein the input interface connects to an emulator that emulates an operation terminal.

7. The recognition apparatus according to claim 1, wherein
the character string is a destination, and
the region is a region of a form in which the destination is described.

8. The recognition apparatus according to claim 1, wherein the image interface acquires an input screen including the character string image and an input field to which an operator inputs the character string.

9. The recognition apparatus according to claim 1, further comprising:
an operation interface connected to an operation unit; and
a display interface connected to a display unit, wherein
in a case where the character recognition processing has failed, the processor displays the character string image on the display unit through the display interface, and inputs, to the input apparatus, an operation signal indicating an operation input to the operation unit through the input interface.

10. A non-transitory storage medium storing a program for causing a computer to execute:
acquiring a character string image including a character string from an input apparatus;
extracting a region of the character string from the character string image;
a function of acquiring a size of the region;
inputting a transformation operation of transforming the character string image based on the size to the input apparatus;
acquiring the transformed character string image;
performing character recognition processing on the transformed character string image; and
inputting the character string to the input apparatus based on a result of the character recognition processing.

11. A recognition system comprising an input apparatus and a recognition apparatus, wherein
the input apparatus includes:
a communication interface that acquires a character string image for which character recognition processing by a first algorithm has failed;
a display interface that outputs an image;
an operation interface that inputs an operation signal; and
a section that outputs the character string image through the display interface, inputs a transformation operation of transforming the character string image through the operation interface, transforms the character string image according to the transformation operation, and outputs the transformed character string image through the display interface, and
the recognition apparatus includes:
an image interface that acquires the character string image from the input apparatus;
an input interface that inputs an operation signal to the input apparatus; and
a processor that extracts a region of a character string from the character string image, acquires a size of the region, inputs the transformation operation to the input apparatus through the input interface based on the size, acquires the transformed character string image through the image interface, performs character recognition processing on the transformed character string image according to a second algorithm different from the first algorithm, and inputs the character string to the input apparatus through the input interface based on a result of the character recognition processing.
